(19) United States
(12) Patent Application Publication
(10) Pub. No.: US 2009/0005524 A1
(43) Pub. Date: Jan. 1, 2009

(54) Catalysts for ethylene polymerization, main catalyst components thereof and process for preparing the same

(75) Inventors: Mingwei Xiao, Shanghai (CN); Shijiong Yu, Shanghai (CN); Xiaofeng Ye, Shanghai (CN)

Correspondence Address: BIRCH STEWART KOLASCH & BIRCH, PO BOX 747, FALLS CHURCH, VA, 22040-0747, US

(73) Assignees: China Petroleum & Chemical Corporation, Beijing (CN); SHANGHAI RESEARCH INSTITUTE OF CHEMICHAL INDUSTRY, Shanghai (CN)

(21) Appl. No.: 12/213,587

(22) Filed: Jun. 20, 2008

(30) Foreign Application Priority Data
Jun. 22, 2007 (CN) 200710042466.8

(51) Int. Cl. C08F 2/00; B01J 31/14; B01J 31/38; B01J 37/00; C08F 4/602

(52) U.S. Cl. 526/128; 502/111; 502/116

(57) ABSTRACT

The invention discloses a process for preparing a titanium-containing main catalyst component, comprising the steps of: (i) reacting a magnesium compound having a formula (MgRX)ₚ(MgX₂)_{q}, where R is an alkyl having 3 to 12 carbon atoms, X is halogen, and q:p=0:1 to 1.0:1, with an alcohol to form a magnesium-containing solution; (ii) reacting said magnesium-containing solution with an inorganic oxide support, to form a first reaction product; (iii) reacting the first reaction product with a halogenating agent, to form a second reaction product; (iv) reacting the second reaction product with a titanium compound and an alkyl aluminum compound, to form the titanium-containing main catalyst component; wherein at least one of the magnesium-containing solution, the first reaction product and the second reaction product is brought into contact with an organic silicon compound having a formula SiR′_{c}(OR″)_{4-c}, where R′ is independently an hydrocarbyl having 1 to 10 carbon atoms, R″ is independently an alkyl having 1 to 6 carbon atoms, and c is 0, 1, 2, or 3, prior to their use in the next step. The invention further discloses a main catalyst component prepared by said process as well as a catalyst.

### CROSS REFERENCE OF RELATED APPLICATIONS

The present application claims the benefit of the Chinese Patent Application No. 200710042466.8, filed on Jun. 22, 2007, which are incorporated herein by reference in its entirety and for all purposes.

### FIELD OF THE INVENTION

The present invention relates to a catalyst useful in ethylene polymerization, to a main catalyst component thereof, and to a process for preparing the same. When used in ethylene polymerization, the catalyst according to the invention exhibits higher activity and may provide a polyethylene having higher bulk density and lower content of hexane extractables.

### BACKGROUND

Because gas phase ethylene polymerization processes has virtues such as having high production efficiency, not needing the removal of solvents, and having lower cost, they are ones of the most commonly used ethylene polymerization processes, and gas phase fluidized bed process is given more attention. At present, catalysts useful in these processes include catalyst systems comprising titanium trichloride or tetrachloride as an active component, magnesium chloride or silica as a carrier, and optionally an electron donor, such as those disclosed in U.S. Pat. No. 4,302,566 and EP0499093. As condensing mode (CM) technique and super condensing mode (SCM) technique are used, productivities of the gas phase ethylene polymerization processes have been enhanced by 50 to 100% and 60 to 300%, respectively, and these processes need catalysts having higher activities and being capable of providing polymers having higher bulk densities.

CN1098866C discloses a catalyst for ethylene polymerization, which is prepared by reacting a powdered magnesium with a haloalkane in an alkane solvent to form a magnesium compound in nascent state of formula (MgRX)ₚ(MgX₂)_{q}; reacting the magnesium compound in nascent state with a titanium halide and an alkyl aluminum in an electron donor as solvent to form a complex; and then impregnating the complex onto a silica carrier. This catalyst exhibits a higher activity, however, it suffers from a problem that bulk densities of the produced resins are lower when it is used in a gas phase ethylene polymerization process operated under condensing mode.

The prior art has disclosed many catalysts that have higher activities and are capable of providing polymers having higher bulk densities. See, for example, U.S. Pat. No. 6,124,412, CN1040443C, CN1231500C, CN1215090C and 1095849C.

Nevertheless, there still is a need for providing a catalyst, which can be easily prepared, has a higher activity and is capable of providing polymers having higher bulk densities.

Additionally, when preparing ethylene copolymer resins, hexane extractables present in the final product are unsuitable for many applications. Therefore, it is very desirable to provide a catalyst which is capable of producing polyethylenes having lower contents of the hexane extractables.

### SUMMARY

An object of the invention is to provide a process for preparing a titanium-containing main catalyst component, comprising the steps of:

(i) reacting a magnesium compound having a formula: (MgRX)ₚ(MgX₂)_{q}, where R is an alkyl having 3 to 12 carbon atoms, X is halogen, and q:p=0:1 to 1.0:1, with an alcohol to form a magnesium-containing solution;

(ii) reacting said magnesium-containing solution with an inorganic oxide support, to form a first reaction product;

(iii) reacting the first reaction product with a halogenating agent, to form a second reaction product;

(iv) reacting the second reaction product with a titanium compound having a formula: Ti(OR¹)ₘCl₄₋ₘ, where R¹ is an alkyl having 1 to 10 carbon atoms and 0≦m≦4, and an alkyl aluminum compound having a formula: R²ₙAlCl₃₋ₙ, where R² is an alkyl having 1 to 14 carbon atoms and 1≦n≦3, to form the titanium-containing main catalyst component;

wherein at least one of the magnesium-containing solution, the first reaction product and the second reaction product is brought into contact with an organic silicon compound having a formula: SiR′_{c}(OR″)_{4-c}, where R′ is independently an hydrocarbyl having 1 to 10 carbon atoms, R″ is independently an alkyl having 1 to 6 carbon atoms, and c is 0, 1, 2, or 3, prior to their use in the next step.

Another object of the invention is to provide a titanium-containing main catalyst component, which is prepared by the above process.

Still another object of the invention is to provide a catalyst for ethylene polymerization, which comprises a reaction product of:

(1) the above titanium-containing main catalyst component; and

(2) an organoaluminum compound,

wherein the molar ratio of Ti in the titanium-containing main catalyst component to Al in the organoaluminum compound is in a range of from 1:30 to 1:300.

Still another object of the invention is to provide a process for producing an ethylene polymer, comprising

(i) contacting ethylene and optional α-olefin comonomer(s) with the catalyst according to the invention under polymerization conditions, to form a polymer; and

(ii) recovering the polymer formed in step (i).

The catalyst of the invention has advantages, including exhibiting higher catalytic activity and giving ethylene polymers that have higher bulk density and lower content of hexane extractables, when used in ethylene polymerization.

### DETAILED DESCRIPTION OF THE PREFERRED EMBODIMENTS

As used herein, the term “polymerization” intends to include homopolymerization and copolymerization. As used herein, the term “polymer” intends to include homopolymer, copolymer and terpolymer.

As used herein, the term “main catalyst component” intends to means procatalyst, which, together with a conventional organoaluminum cocatalyst, for example an alkyl aluminum, constitutes the catalyst for ethylene polymerization.

In the first aspect, the present invention provides a process for preparing a titanium-containing main catalyst component, comprising the steps of:

(i) reacting a magnesium compound having a formula: (MgRX)ₚ(MgX₂)_{q}, where R is an alkyl having 3 to 12 carbon atoms, X is halogen, and q:p=0:1 to 1.0:1, with an alcohol to form a magnesium-containing solution;

(ii) reacting said magnesium-containing solution with an inorganic oxide support, to form a first reaction product;

(iii) reacting the first reaction product with a halogenating agent, to form a second reaction product; and

(iv) reacting the second reaction product with a titanium compound having a formula: Ti(OR¹)ₘCl₄₋ₘ, where R¹ is an alkyl having 1 to 10 carbon atoms and 0≦m≦4, and an alkyl aluminum compound having a formula: R²ₙAlCl₃₋ₙ, where R² is an alkyl having 1 to 14 carbon atoms and 1≦n≦3, to form the titanium-containing main catalyst component;

wherein at least one of the magnesium-containing solution, the first reaction product and the second reaction product is brought into contact with an organic silicon compound having a formula: SiR′_{c}(OR″)_{4-c}, where R′ is independently an hydrocarbyl having 1 to 10 carbon atoms, R″ is independently an alkyl having 1 to 6 carbon atoms, and c is 0, 1, 2, or 3, prior to their use in the next step.

In an embodiment of the invention, the magnesium compound of the formula (MgRX)ₚ(MgX₂)_{q} is prepared by reacting a powdered magnesium with an alkyl monohalide having 3 to 12 carbon atoms in an ether solvent, wherein the molar ratio of the powdered magnesium to the alkyl monohalide is in a range of from 1:1 to 1:3, and preferably from 1:1 to 1:2. In the formula (MgRX)ₚ(MgX₂)_{q}, R is an alkyl having from 3 to 12 carbon atoms, preferably from 3 to 8 carbon atoms; X is a halogen atom, and preferably chlorine atom; and q/p ratio is in a range of from 0 to 1.0, and preferably from 0.05 to 0.95.

An initiating system may be used in the reaction of the powdered magnesium and the alkyl monohalide. In a preferred embodiment, the initiating system consists of iodine, a C₄₋₈-alkyl titanate, an alcohol having 2 to 6 carbon atoms, and a haloalkane having 3 to 6 carbon atoms, wherein the components consisting of the initiating system are used in such amounts that iodine/magnesium ratio by weight is in a range of from 0.01 to 0.2, C₄₋₈-alkyl titanate/magnesium ratio is in a range of from 0.01 to 0.5, alcohol/magnesium ratio is in a range of from 0.01 to 0.05, and haloalkane/magnesium ratio is in a range of from 0.05 to 0.2.

In a preferred embodiment of the invention, the magnesium compound of the formula (MgRX)ₚ(MgX₂)_{q} is prepared as follows. At 20° C. to 30° C., the initiating system and the ether solvent are added into a powdered magnesium, and the resultant mixture is stirred for 2 to 10 hours. The alkyl monohalide having 3 to 12 carbon atoms is added into the reaction mixture in one-portion, portionwise, or dropwise. If the alkyl monohalide is added portionwise or dropwise, the addition may be completed over 10 minutes to 2 hours. Upon completion of the addition, the reaction is heated to a temperature of 50° C. to 70° C. and maintained for 2 to 8 hours, preferably 3 to 6 hours, to give a solution of said magnesium compound. The ether solvents useful in the reaction include aliphatic hydrocarbyl ethers, aromatic hydrocarbyl ethers, aliphatic hydrocarbyl-aromatic hydrocarbyl ethers, cyclic ethers, and mixture thereof. Examples include, but are not limited to, diethyl ether, di-n-propyl ether, di-n-butyl ether, di-isobutyl ether, diphenyl ether, methyl phenyl ether, tetrahydrofuran, with tetrahydrofuran being preferred.

The magnesium compound useful in the invention is characterized by a q/p ratio of from 0:1 to 1.0:1, and preferably from 0.05:1 to 0.95:1. Such a ratio suggests that the magnesium compound is different from a traditional Grignard reagent, and it allows the presence of an amount of magnesium halide. This characteristic makes the preparation of the magnesium compound easier, but also a solution of the magnesium compound in an ether solvent has a less viscosity than that of a same volume, same concentration solution of magnesium dihalide so that the magnesium compound can be more easily supported on a carrier.

In an embodiment, the alcohol compounds useful in the invention are linear, branched, or cyclic aliphatic alcohols having 2 to 12, and preferably 4 to 8 carbon atoms. Examples include, but are not limited to, isobutanol, 2-ethylhexanol, 2-methylpentanol, 2-ethylbutanol, and octanol, with 2-ethylhexanol being preferred. The alcohol compounds can be used alone or in a combination. The alcohol compounds are used in an amount of from 1 to 2 moles, and preferably from 1 to 1.5 moles, of alcohol per mole of Mg in the magnesium compound.

According to the invention, the magnesium compound and the alcohol compound are allowed to react in an inert solvent, preferably the ether solvent in which the magnesium compound is prepared as described above, to form the magnesium-containing solution. In an embodiment, the magnesium-containing solution can be prepared by adding dropwise the alcohol compound into the solution of the magnesium compound in an ether solvent at a temperature of 20° C. to 30° C.; upon completion of the addition, elevating the temperature to 40° C. to 50° C. and maintaining at that temperature for 1 to 3 hours.

According to the invention, the magnesium-containing solution, which has optionally contacted with an organic silicon compound described below, will react with an inorganic oxide support.

The inorganic oxide support may be any of those conventionally used in the art, including, but not limited to, silica, alumina, and mixtures thereof. In a preferred embodiment, the inorganic oxide support is a silica having an average particle size of from 10 μm to 250 μm, and preferably from 5 μm to 100 μm, and a specific surface area of at least 3 m²g, preferably from 3 to 500 m²/g, more preferably from 5 to 400 m²/g. The inorganic oxide support may be used in an amount of 0.2 to 1 gram per millimole of Mg in the magnesium compound.

The silica support used in the present invention is preferably subjected to a heat treatment and/or a chemical treatment prior to use to remove moisture in the support and a portion of hydroxy groups on the surface of the support. The moisture contained in the silica support can be removed by a heat treatment performed at 100-200° C., and the hydroxy groups on the surface of the silica can be removed by calcination performed at a temperature over 200° C. The higher temperature, the less amount of the hydroxy groups on the surface of the silica. However, excessively high temperature (such as above 800° C.) may result in reduction of the pore volume of silica support, even breakage and agglomeration of support particles. In contrast, the removal of hydroxy groups on the surface of a silica support by a chemical method not only increases the activity of catalyst but also improves the morphology of support particles. For example, aluminum alkyls can be used to chemically activate the silica support.

In an embodiment, the silica support maw be treated by heating it to a temperature of from 500 to 800° C., and preferably from 600 to 700° C., and maintaining at that temperature for 2 to 12 hours, and preferably 3 to 10 hours, in a fluidized bed through which a gas stream such as nitrogen or argon is passed.

In an embodiment, the silica support may be treated by heating the silica support at a temperature of from 100 to 800° C., and preferably from 120 to 700° C. for 2 to 12 hours, and preferably 3 to 10 hours, to give a heat-treated silica; slurrying the heat-treated silica in an alkane solvent; adding an alkyl aluminum compound in an amount of from 0.1 to 10 wt %, and preferably from 0.2 to 8 wt %, based on the weight of the silica, to the resulting slurry; stirring the resulting mixture at room temperature for 0.5 to 4 hours; and finally evaporating the alkane solvent by heating, to give a silica support having excellent flowability.

In an embodiment of the invention, the inorganic oxide support is brought into contact with the above described magnesium-containing solution at ambient temperature. Then the resultant mixture is stirred at a temperature of 30 to 60° C. for 1 to 2 hours. Next, the reaction mixture is dried to give a solid powder as the first reaction product, for example, by elevating the temperature to the boiling point of the solvent or higher, preferably under a nitrogen flow. In some embodiments where an ether solvent is employed, the reaction mixture is dried to such an extent that the content of residual ether solvent in the resultant solids is in a range of from 2 to 6 wt %, to give the first reaction product.

According to the invention, the first reaction product will react with a halogenating agent. In an embodiment, prior to the reaction between the first reaction product and the halogenating agent, the first reaction product is first brought into contact with an organic silicon compound as described below. The halogenating agents useful in the invention include:

alkyl aluminum halides of a formula R³_{b}AlY_{3-b}, where R³ is independently an alkyl having 1 to 14 carbon atoms, 1≦b<3, and Y is halogen, and preferably chlorine;

halides of a formula MYᵢ, where M represents Si, C, B, Ti, or Pb, i is equal to the valence of M, and Y is halogen, and preferably chlorine; and

mono- or multihalo-alkanes having 1 to 10 carbon atoms, and preferably mono- or multichloro-alkanes having 1 to 10 carbon atoms.

Examples of the alkyl aluminum halide include, but are not limited to, diethyl aluminum chloride, ethyl aluminum dichloride, diisopropyl aluminum chloride, ethyl aluminum sesquichloride, and butyl aluminum sesquichloride, with diethyl aluminum chloride and ethyl aluminum dichloride being preferred.

Examples of the halide include, but are not limited to, silicon tetrachloride, titanium tetrachloride, boron trichloride, carbon tetrachloride, and lead tetrachloride, with silicon tetrachloride being preferred.

Examples of the halo-alkanes include, but are not limited to, n-butyl chloride, n-propyl chloride, ethyl chloride, n-amyl chloride, 2-chlorobutane, 2-chloropropane, 2-chloroheptane, 3-chloroheptane, 2,2-dichloropropane, 2,2-dichlorobutane, 1,3-dichlorobutane, 1,2-dichloropropane, and t-butyl chloride, with n-butyl chloride being preferred.

The halogenating agents can be used alone or in a combination. When reacting with the first reaction product, the halogenating agents are used in an amount of from 1 to 10 moles, and preferably from 1 to 8 moles, of halogenating agent per mole of Mg in the magnesium compound.

The reaction between the halogenating agent and the first reaction product can be carried out in the presence of an inert diluent. In an embodiment, the inert diluent is an alkane solvent, such as hexane, n-pentane, isopentane, n-hexane, n-heptane, n-octane and the like, and mixtures thereof, with n-hexane and n-heptane being preferred. For example, the halogenating agent may be brought into account with the first reaction product at ambient temperature, and then the mixture is warmed to a temperature of from 30° C. to 80° C. and further stirred for 1 to 3 hours, to form the second reaction product. The inorganic oxide support may be used in an amount of from 0.2 to 1 gram per millimole of Mg in the magnesium compound.

According to the invention, the second reaction product will react with at least one titanium compound having a formula Ti(OR¹)ₘCl₄₋ₘ, where R¹ is an alkyl having 1 to 10 carbon atoms and 0≦m≦4, and at least one alkyl aluminum compound having a formula R²ₙAlCl₃₋ₙ, where R² is an alkyl having 1 to 14 carbon atoms and 1≦n≦3, to form the titanium-containing main catalyst component of the invention.

Examples of suitable titanium compound useful in the invention include, but are not limited to, titanium tetrachloride, tetrabutyl titanate, tetraisopropyl titanate, methoxy titanium trichloride, ethoxy titanium trichloride, propoxy titanium trichloride, isopropoxy titanium trichloride, and butoxy titanium trichloride, with titanium tetrachloride being preferred. The titanium compounds can be used alone or in a combination, and in an amount of from 0.15 to 1.0, and preferably from 0.2 to 0.5 moles of titanium compound per mole of Mg in the magnesium compound.

Examples of suitable alkyl aluminum compound useful in the invention include, but are not limited to, triethyl aluminum, triisopropyl aluminum, triisobutyl aluminum, tri-n-hexyl aluminum, tri-n-octyl aluminum, tri(2-ethylhexyl) aluminum, diethyl aluminum chloride, ethyl aluminum dichloride, diisopropyl aluminum chloride, ethyl aluminum sesquichloride, and butyl aluminum sesquichloride, with diethyl aluminum chloride being preferred. The alkyl aluminum compounds can be used alone or in a combination, and in an amount of from 0.5 to 1.5, and preferably from 1.0 to 1.5 moles of the alkyl aluminum compound per mole of the titanium compound.

The reaction of the titanium compound and the alkyl aluminum compound with the second reaction product can be carried out according to a method known per se. For example, the titanium compound and the alkyl aluminum compound may be added, either in one-portion or dropwise, into a suspension of the second reaction product in an inert diluent, preferably the diluent used in step (iii) of the process according to the invention, at a relatively low temperature, such as at 0° C. Upon the completion of the addition, the reaction mixture is stirred at a temperature of from 10° C. to 80° C., preferably from 20° C. to 60° C. for 0.5 to 10 hours, preferably 1 to 5 hours. Then the solvent is removed, for example by heating the reaction mixture at 60 to 85° C. under a nitrogen flow, to give a titanium-containing main catalyst component.

According to the invention, at least one of the magnesium-containing solution, the first reaction product and the second reaction product is brought into contact with at least one organic silicon compound having a formula SiR′_{c}(OR″)_{4-c}, where R′ is independently an hydrocarbyl having 1 to 10 carbon atoms, R″ is independently an alkyl having 1 to 6 carbon atoms, and c is 0, 1, 2, or 3, prior to their use in the next step.

The organic silicon compound useful in the invention is one containing at least one alkoxy group. Examples include, but are not limited to, tetramethoxysilicane, tetraethoxysilicane, tetrapropoxysilicane, tetraisopropoxysilicane, tetrabutoxysilicane, tetra(2-ethylhexoxy)silicane, methyltrimethoxysilicane, methyltriethoxysilicane, ethlytrimethoxysilicane, ethyltriethoxysilicane, n-propyltriethoxysilicane, n-propyltrimethoxysilicane, decyltrimethoxysilicane, decyltriethoxysilicane, cyclopentyltrimethoxysilicane, cyclopentyltriethoxysilicane, 2-methylcyclopentyltrimethoxysilicane, 2,3-dimethylcyclopentyltrimethoxysilicane, cyclohexyltrimethoxysilicane, cyclohexyltriethoxysilicane, vinyltrimethoxysilicane, vinyltriethoxysilicane, vinyltributoxysilicane, t-butyltriethoxysilicane, n-butyltrimethoxysilicane, n-butyltriethoxysilicane, iso-butyltrimethoxysilicane, iso-butyltriethoxysilicane, cyclohexyltriethoxysilicane, cyclohexyltrimethoxysilicane, phenyltrimethoxysilicane, phenyltriethoxysilicane, ethyltriisopropoxysilicane, dimethyldimethoxysilicane, dimethyldiethoxysilicane, diisopropyldimethoxysilicane, diisopropyldiethoxysilicane, t-butylmethyldimethoxysilicane, t-butylmethyldiethoxysilicane, t-amylmethyldiethoxysilicane, dicyclopentyldimethoxysilicane, dicyclopentyldiethoxysilicane, nethylcyclopentyldiethoxysilicane, methylcyclopentyldimethoxysilicane, diphenyldimethoxysilicane, diphenyldiethoxysilicane, methylphenyldiethoxysilicane, methylphenyldimethoxysilicane, di(o-tolyl)dimethoxysilicane, di(o-tolyl)diethoxysilicane, di(m-tolyl)dimethoxysilicane, di(m-tolyl)diethoxysilicane, di(p-tolyl)dimethoxysilicane, di(p-tolyl)diethoxysilicane, trimethylmethoxysilicane, trimethylethoxysilicane, tricyclopentylmethoxysilicane, tricyclopentylethoxysilicane, dicyclopentylmethylmethoxysilicane, and cyclopentyldimethylmethoxysilicane. Among these, the preferred are tetraalkoxysilicanes, for example, tetraethoxysilicane and tetrabutoxysilicane, and the most preferred is tetraethoxysilicane. These organic silicon compounds may be used alone or in combination. In an embodiment of the invention, the organic silicon compound is used in an amount of from 0.1 to 1.0 moles, and preferably from 0.1 to 0.5 moles, of organic silicon compound per mole of Mg in the magnesium compound.

In a preferred embodiment of the invention, the magnesium-containing solution from step (i) is first brought into contact with at least one of the organic silicon compounds, prior to the contact of it with the inorganic oxide support. In an aspect of this embodiment, the at least one organic silicon compound may be added into the magnesium-containing solution at ambient temperature, either in one-portion or dropwise. Upon completion of the addition, the mixture is allows to react at a temperature of from 40 to 70° C. for 1 to 3 hours, to form an organic silicon compound-contacted, magnesium-containing solution, which will react with the inorganic oxide support in step (ii) of the process according to the invention.

In another preferred embodiment of the invention, the second reaction product from step (iii) is first brought into contact with at least one of the organic silicon compound, prior to its use in step (iv). In an aspect of this embodiment, the at least one organic silicon compound may be added into a suspension of the second reaction product in an inert diluent, preferably the diluent used in step (iii) of the process according to the invention, at ambient temperature, either in one-portion or dropwise. Upon completion of the addition, the mixture is allows to react at a temperature of from 40 to 70° C. for 1 to 3 hours, to form an organic silicon compound-contacted second reaction product, which will react with the titanium compound and the alkyl aluminum compound in step (iv) of the process according to the invention.

In the second aspect, the invention provides a titanium-containing main catalyst component, which is prepared by a process described above.

In an embodiment, prior to the use of the titanium-containing main catalyst component in a polymerization process, it may be pre-activated with an activator. Suitable activators include alkyl aluminum compounds, such as diethyl aluminum chloride, triethyl aluminum, tri-n-hexyl aluminum, ethyl aluminum dichloride and mixtures thereof. In the preactivation, the amount of the activator used may be determined according to the content of the residual ether solvent in the titanium-containing main catalyst component. In general, the activator is used in an amount of from 60 to 70 percent by mole, based on the moles of the residual ether solvent.

In the third aspect, the invention provides a catalyst for ethylene polymerization, which comprises a reaction product of:

(1) the titanium-containing main catalyst component of the invention; and

(2) an organoaluminum compound as a cocatalyst,

wherein the molar ratio of Ti in the titanium-containing main catalyst component to Al in the organoaluminum compound is in a range of from 1:30 to 1:300, and preferably from 1:50 to 1:250.

Examples of the organoaluminum compound useful in the present invention include, but are not limited to triethyl aluminum, diethyl aluminum chloride, triisobutyl aluminum, tri-n-hexyl aluminum, and mixtures thereof, with triethyl aluminum being preferred.

The catalyst of the present invention can be used in any suitable polymerization process, including suspension, solution and gas phase polymerization, preferably gas phase polymerization, especially gas phase polymerization in a fluidized bed reactor.

In the ethylene polymerization, one or more co-monomers may be used to adjust density of polyethylene products. Typical co-monomers are aliphatic alpha-olefins having from 3 to 8 carbon atoms. Suitable alpha-olefins include propene, 1-butene, 1-pentene, 1-hexene, 4-methyl-1-pentene, 1-heptene, and 1-octene. The preferred alpha-olefins are 1-butene and 1-hexene. Polyethylene products having a density of from 0.920 to 0.958 g/cc can be prepared by adding co-monomer(s).

In order to adjust melt index of polymers, a chain-transfer agent may be used. Suitable chain-transfer agent is hydrogen, or diethyl zinc added to the catalyst. When partial pressure of hydrogen introduced varies in a range of from 10 to 50 percent, polyethylene products having a melt index MI_{2.16} of from 0 to 60 g/10 minutes can be obtained.

Thus, in the fourth aspect, the invention provides a process for producing an ethylene polymer, comprising

(i) contacting ethylene and optional α-olefin comonomer(s) with the catalyst according to the invention under polymerization conditions, to form a polymer; and

(ii) recovering the polymer formed in step (i).

The catalysts for ethylene polymerization according to the present invention as well as the processes for preparation thereof have the following advantages:

1. The catalysts according to the present invention can be prepared in a simple manner and are completely suitable for production and application in industrial scale.

2. The polyethylene powders produced by using said catalysts under the conditions described herein have bulk densities as high as 0.34 to 0.38 g/cm³ and less fines.

3. The catalysts have polymerization activities as high as 7,000 to 8,000 grams polyethylene per gram catalyst under the conditions: polymerization temperature, 80° C.; polymerization pressure, 1.0 MPa; and polymerization time, 2 hours.

4. The polyethylene produced by using said catalysts has low content of the hexane extractables.

### EXAMPLES

The present invention will be explained more detailedly with reference to the following examples, but the examples are intended to limit the scope of the invention in any way.

In the examples of the specification, analysis of main components of the catalysts and test of main properties of polyethylene products are performed using the following methods:

content of Mg²⁺ is determined by EDTA (disodium ethylenediamine tetraacetic acid) titration;

content of Cl⁻ is determined by potentiometer titration;

content of Ti is analyzed by chromatography;

amount of residual THF (tetrahydrofuran) is determined by analyzing the extract obtained by extracting solid product with acetone using gas chromatography; and

bulk density of polymer is measured according to GB 1636-1979.

Prior to being used in the preparation of the titanium-containing main catalyst component, the silica support was activated as follows:

(i) 20 grams of silica were charged into a fluidized bed reactor, headed to 600° C. under a nitrogen flow, maintained at that temperature for 10 hours, and then cooled gradually to ambient temperature to give a heat-treated silica.

(ii) The heat-treated silica was slurried in 100 ml of hexane, and 2 ml of triethyl aluminum was added to the resultant slurry at ambient temperature. Then the mixture was stirred at 30° C. for 1.5 hours, and then the hexane was evaporated to give a silica support having excellent flowability.

A magnesium compound was prepared as follows:

At room temperature, to a 500 ml 5-necked glass reaction vessel were charged with 50 ml of THF, 2.4576 g of powdered magnesium, 0.2 g of iodine, 0.6 ml of tetrabutoxy titanium. 0.2 ml of isobutanol and 0.3 ml of n-butyl chloride, and the mixture was stirred for 2 hours. Then the temperature was elevated to 60° C., 19 ml of n-butyl chloride was dropwise added to the reactor over 1 hour. When about half amount of the n-butyl chloride had been added, 150 ml of THF was added to the reactor, then the other n-butyl chloride was added. Upon completion of the addition, the mixture was maintained at 60° C. for 3 hours and a black solution of magnesium chloride in the nascent state was obtained. The solution was found to contain 0.4490 mmol/ml of Mg and 0.6421 mmol/ml of Cl so that Cl/Mg was 1.43, and the magnesium chloride in the nascent state could be expressed by a rational formula of (BuMgCl)(MgCl₂)_{0.75}.

Slurry Polymerization Evaluation Procedure:

In the examples, slurry polymerization was performed as follows: 1000 ml of hexane and 40 to 50 mg of a titanium-containing main catalyst component were added to a 2 L reactor. An amount of triethyl aluminum as a cocatalyst was added to the reactor so that the molar ratio of Al to Ti was 200. The reactor was heated to 70° C., and then ethylene was added to the reactor to maintain a total pressure of 1.0 MPa. Then the temperature was elevated further to 85° C. and maintained for 2 hours. Then the addition of ethylene was stopped, and the reactor was quickly cooled to room temperature and vented. The polymer slurry was recovered and polyethylene powder was separated from the hexane.

Gas Phase Polymerization Evaluation Procedure:

In the examples, gas phase polymerization was performed as follows: the polymerization reaction was carried out in a fluidized bed reactor having a diameter of 100 mm and a height of 1500 mm. First, to the fluidized bed reactor were charged 100 g of an oven-dried base of particulate polyethylene, about 1.0 g of the titanium-containing main catalyst component and an amount of triethyl aluminum as cocatalyst (Al:Ti=200). The polymerization was performed at a total pressure of 2.0 MPa, with the composition of the feed gas being ethylene 40%, H₂ 30%, butene 15%, and nitrogen gas 15%, and at a temperature of 90° C. for 3 hours, with white polyethylene being obtained.

### Example 1

### (1) Preparation of a Magnesium-Containing Solution

To a 5-necked glass reaction vessel were charged with 80 ml of the above prepared magnesium compound having the rational formula of (BuMgCl)(MgCl₂)_{0.75}, and then 7 ml of 2-ethylhexanol was added dropwise to the reactor at 30° C. over 0.5 hours. Upon completion of the addition, the temperature was elevated to 50° C. and maintained for 1.5 hours, to give a magnesium-containing solution.

### (2) Reaction of the Magnesium-Containing Solution with an Organic Silicon Compound

The magnesium-containing solution from step (1) was cooled to ambient temperature, and then 4 ml of tetraethoxy silicane was added thereto. The reactor was heated to 60° C. and maintained at that temperature for 2 hours, to give an impregnating solution.

### (3) Impregnation of Silica

The above impregnating solution was cooled to 20° C., and 12 g of the activated silica was added slowly thereto with stirring. After stirred for 1.5 hours, the reaction mixture was heated to 70° C., and then dried under a nitrogen flow to dry, giving a solid powder. The solid powder was found to have a content of residue THF of 5 wt %.

### (4) Reaction with a Halogenating Agent

To the above solid powder was added with 100 ml of hexane. After stirring for 5 min, 11 ml of ethyl aluminum dichloride was added to the reaction vessel, and the content was stirred at ambient temperature for 1.5 hours. Then the content was heated to 65° C. and maintained at that temperature for 2 hours, giving a mixture.

### (5) Reaction with a Titanium Compound and an Alkyl Aluminum Compound

The mixture from step (4) was cooled to ambient temperature, and 50 ml of hexane, 1.4 ml of titanium tetrachloride and 1.6 ml of diethyl aluminum chloride were added thereto. Upon completion of the addition, the temperature was elevated to 65° C. and maintained for 3 hours. Then hexane was evaporated to give a titanium-containing solid main catalyst component.

The catalyst component was evaluated in a slurry polymerization carried out as described above and results are shown in the Table 1 below. The catalyst component was also evaluated in a gas phase polymerization carried out as described above and results are shown in the Table 2 below.

### Example 2

A solid powder was prepared according to steps (1), (2) and (3) of the Example 1.

### (4) Reaction with a Halogenating Agent

To the above solid powder was added with 100 ml of hexane. After stirring for 5 min, 9 ml of t-butyl chloride was added to the reaction vessel, and the content was stirred at ambient temperature for 1.5 hours. Then the content was heated to 65° C. and maintained at that temperature for 2 hours, giving a mixture.

### (5) Reaction with a Titanium Compound and an Alkyl Aluminum Compound

The mixture from step (4) was cooled to ambient temperature, and 50 ml of hexane, 1.5 ml of titanium tetrachloride and 2 ml of diethyl aluminum chloride were added thereto. Upon completion of the addition, the temperature was elevated to 65° C. and maintained for 3 hours. Then hexane was evaporated to give a titanium-containing solid main catalyst component.

The catalyst component was evaluated in a slurry polymerization carried out as described above and results are shown in the Table 1 below. The catalyst component was also evaluated in a gas phase polymerization carried out as described above and results are shown in the Table 2 below.

### Example 3

A solid powder was prepared according to steps (1), (2) and (3) of the Example 1.

### (4) Reaction with a Halogenating Agent

To the above solid powder was added with 100 ml of hexane. After stirring for 5 min, 6 ml of silicon tetrachloride was added to the reaction vessel, and the content was stirred at ambient temperature for 1.5 hours. Then the content was heated to 65° C. and maintained at that temperature for 2 hours, giving a mixture.

### (5) Reaction with a Titanium Compound and an Alkyl Aluminum Compound

The mixture from step (4) was cooled to ambient temperature, and 50 ml of hexane, 1.5 ml of titanium tetrachloride and 2 ml of diethyl aluminum chloride were added thereto. Upon completion of the addition, the temperature was elevated to 65° C. and maintained for 3 hours. Then hexane was evaporated to give a titanium-containing solid main catalyst component.

The catalyst component was evaluated in a slurry polymerization carried out as described above and results are shown in the Table 1 below The catalyst component was also evaluated in a gas phase polymerization carried out as described above and results are shown in the Table 2 below.

### Example 4

A magnesium-containing solution was prepared according to step (1) of the Example 1.

### (2) Impregnation of Silica

The magnesium-containing solution from step (1) was cooled to ambient temperature, and then 10 g of the activated silica was added slowly thereto with stirring. After stirred for 1.5 hours, the reaction mixture was heated to 70° C., and then dried under a nitrogen flow to dry, giving a solid powder. The solid powder was found to have a content of residue THF of 3.5 wt %.

### (3) Reaction with a Halogenating Agent

To the above solid powder was added with 100 ml of hexane. After stirring for 5 min, 11 ml of butyl chloride was added to the reaction vessel, and the content was stirred at ambient temperature for 1.5 hours. Then the content was heated to 65° C. and maintained at that temperature for 2 hours, giving a mixture.

### (4) Reaction with an Organic Silicon Compound

The mixture from step (3) was cooled to ambient temperature, and then 2.4 ml of tetraethoxy silicane was added thereto. The reactor was heated to 60° C. and maintained at that temperature for 2 hours, to give a mixture.

### (5) Reaction with a Titanium Compound and an Alkyl Aluminum Compound

The mixture from step (4) was cooled to ambient temperature, and 50 ml of hexane, 1.5 ml of titanium tetrachloride and 2 ml of diethyl aluminum chloride were added thereto. Upon completion of the addition, the temperature was elevated to 65° C. and maintained for 3 hours. Then hexane was evaporated to give a titanium-containing solid main catalyst component.

The catalyst component was evaluated in a slurry polymerization carried out as described above and results are shown in the Table 1 below. The catalyst component was also evaluated in a gas phase polymerization carried out as described above and results are shown in the Table 2 below.

### Comparative Example 1

A magnesium-containing solution was prepared according to step (1) of the Example 1.

### (2) Impregnation of Silica

The magnesium-containing solution from step (1) was cooled to ambient temperature, and then 12 g of the activated silica was added slowly thereto with stirring. After stirred for 1.5 hours, the reaction mixture was heated to 70° C., and then dried under a nitrogen flow to dry, giving a solid powder. The solid powder was found to have a content of residue THF of 2.5 wt %.

### (3) Reaction with a Halogenating Agent

To the above solid powder was added with 100 ml of hexane. After stirring for 5 min, 11 ml of ethyl aluminum dichloride was added to the reaction vessel, and the content was stirred at ambient temperature for 1.5 hours. Then the content was heated to 65° C. and maintained at that temperature for 2 hours, giving a mixture.

### (4) Reaction with a Titanium Compound and an Alkyl Aluminum Compound

The mixture from step (3) was cooled to ambient temperature, and 50 ml of hexane, 1.7 ml of titanium tetrachloride and 1.8 ml of diethyl aluminum chloride were added thereto. Upon completion of the addition, the temperature was elevated to 65° C. and maintained for 3 hours. Then hexane was evaporated to give a titanium-containing solid main catalyst component.

The catalyst component was evaluated in a slurry polymerization carried out as described above and results are shown in the Table 1 below. The catalyst component was also evaluated in a gas phase polymerization carried out as described above and results are shown in the Table 2 below.

### Comparative Example 2

At room temperature, to a 500 ml 5-necked glass reaction vessel were charged with 50 ml of hexanel, 3 g of powdered magnesium, 0.24 g of iodine, 0.7 ml of tetrabutoxy titanium, 0.2 ml of isobutanol and 0.4 ml of n-butyl chloride, and the mixture was stirred for 2 hours. Then the temperature was elevated to 60° C., and 36 ml of n-butyl chloride was dropwise added to the reactor over 1.5 hour. Upon Completion of the addition, the mixture was maintained at 60° C. for 3 hours and then the hexane was evaporated, to give a magnesium compound in the nascent state as solids. After cooling the magnesium compound in the nascent state to the room temperature, 250 ml of THF was added thereto and the mixture was stirred to form a solution. The solution was found to contain 0.3582 mmol/ml of Mg and 0.6304 mmol/ml of Cl so that Cl/Mg was 1.76, and the magnesium compound in the nascent state could be expressed by a rational formula of (BuMgCl)(MgCl₂)_{3.2}.

At room temperature, to the above solution were added 5 ml of titanium tetrachloride and 7 ml of diethyl aluminum chloride, and the mixture was heated to 60° C. while stirring and maintained at that temperature for 3.5 hours, to give a solution. After cooling the solution to room temperature, 55 g of the treated silica was added to the solution, and the mixture was heated to 60° C. while stirring and maintained at that temperature for 3 hours. Then THF was removed to give a solid titanium-containing main catalyst component, which is found to contain 5 wt % of residual THF.

The catalyst component was evaluated in a slurry polymerization carried out as described above and results are shown in the Table 1 below. The catalyst component was also evaluated in a gas phase polymerization carried out as described above and results are shown in the Table 2 below.

Particle size distribution of the polyethylenes obtained in gas polymerization for Example 1 and Comparative Example 2 are shown in Table 3 below.

TABLE 1

| | Polymerization Activity | Bulk density | Ti content |
|---|---|---|---|
| Example No. | (gPE/gCat)* | (g/cm³) | (wt %) |
| 1 | 7800 | 0.37 | 2.5 |
| 2 | 8000 | 0.39 | 2.2 |
| 3 | 7890 | 0.37 | 2.0 |
| 4 | 8321 | 0.38 | 2.1 |
| Comp. Ex. 1 | 7000 | 0.35 | 2.3 |
| Comp. Ex. 2 | 6500 | 0.32 | 2.0 |

*gPE/gCat represents grams polymer per gram catalyst.

TABLE 2

| | Polymerization | | | |
|---|---|---|---|---|
| | Activity | Melt index | Density | Bulk density |
| Example No. | (gPE/gCat) | (g/10 min) | (g/cm³) | (g/cm³) |
| 1 | 5300 | 19.4 | 0.923 | 0.36 |
| 2 | 5500 | 18.5 | 0.922 | 0.37 |
| 3 | 6100 | 20.1 | 0.921 | 0.37 |
| 4 | 6310 | 19.3 | 0.924 | 0.38 |
| Comp. Ex. 1 | 5120 | 18.0 | 0.920 | 0.36 |
| Comp. Ex. 2 | 4500 | 18.4 | 0.922 | 0.31 |

TABLE 3

| | <20 | 20-40 | 40-75 | 75-120 | 120-200 | >200 |
|---|---|---|---|---|---|---|
| | mesh | mesh | mesh | mesh | mesh | mesh |
| Example No. | (wt %) | (wt %) | (wt %) | (wt %) | (wt %) | (wt %) |
| Example 1 | 8.9 | 15.1 | 40.7 | 30.8 | 4.3 | 0.2 |
| Comp. Ex. 2 | 10.3 | 18.3 | 35.0 | 29.7 | 5.6 | 1.1 |

### Comparative Example 3

A main catalyst component was prepared according to the procedure as described in Example 7 of US 2005/0170949A1.

A slurry polymerization was carried out by using the above main catalyst component under the following conditions: solvent: hexane; hydrogen partial pressure: 0.2 MPa; ethylene partial pressure: 0.8 MPa; total pressure: 1.0 MPa; polymerization temperature; 85° C.; and polymerization time: 2 hours. The results are shown in Table 4 below.

The results obtained by using the main catalyst component from Example 1 under the same conditions are also shown in the Table 4.

TABLE 4

| | Polymerization | | | Hexane |
|---|---|---|---|---|
| | Activity | | Bulk Density | Extractables |
| Ex. No. | (gPE/gCat) | MI_{2.16} | g/cm³ | Content* |
| Comp. Ex. 3 | 4977 | 2.14 | 0.388 | 1.16% |
| Ex. 1 | 3412 | 0.97 | 0.394 | 0.782% |

*Hexane extractables content was measured by extracting the polymer powder obtained from the polymerization in boiling hexane for 12 hours.

Furthermore, a gas phase polymerization was carried out by using the main catalyst component of Comparative Example 3 under the following conditions: total pressure: 2.0 MPa; hydrogen partial pressure; 0.3 MPa; ethylene partial pressure: 0.8 MPa; nitrogen partial pressure: 0.9 MPa; polymerization temperature: 90° C.; and polymerization time: 3 hours. The results are shown in Table 5 below.

The result obtained by using the main catalyst component from Example 1 in a gas phase polymerization carried out under the following conditions: total pressure: 2.0 MPa; hydrogen partial pressure; 0.6 MPa; ethylene partial pressure: 0.8 MPa; nitrogen partial pressure: 0.6 MPa; polymerization temperature: 90° C.; and polymerization time: 3 hours, are also shown in the Table 5.

TABLE 5

| | | | Polymerization Activity | | Bulk Density | Hexane Extractables |
|---|---|---|---|---|---|---|
| Ex. No. | H₂ | C₂H₄ | (gPE/gCat) | MI_{2.16} | g/cm³ | Content |
| Comp. Ex. 3 | 0.3 MPa | 0.8 MPa | 10473 | 8.94 | 0.354 | 3.56% |
| Ex. 1 | 0.6 MPa | 0.8 MPa | 5169 | 9.67 | 0.381 | 2.87% |

The patents, patent applications, non-patent literatures and testing methods cited in the specification are incorporated herein by reference.

While the invention has been described with reference to exemplary embodiments, it will be understood by those skilled in the art that various changes and modifications may be made without departing from the spirit and scope of the invention. Therefore, the invention is not limited to the particular embodiments disclosed as the best mode contemplated for carrying out this invention, but the invention will include all embodiments falling within the scope of the appended claims.

What is claimed is:

1. A process for preparing a titanium-containing main catalyst component, comprising the steps of:
(i) reacting a magnesium compound having a formula (MgRX)ₚ(MgX₂)_{q}, where R is an alkyl having 3 to 12 carbon atoms, X is halogen, and q:p=0:1 to 1.0:1, with an alcohol to form a magnesium-containing solution;
(ii) reacting said magnesium-containing solution with an inorganic oxide support, to form a first reaction product;
(iii) reacting the first reaction product with a halogenating agent, to form a second reaction product;
(iv) reacting the second reaction product with a titanium compound having a formula Ti(OR¹)ₘCl₄₋ₘ, where R¹ is an alkyl having 1 to 10 carbon atoms and 0≦m≦4, and an alkyl aluminum compound having a formula R²ₙAlCl₃₋ₙ, where R² is an alkyl having 1 to 14 carbon atoms and 1≦n≦3, to form the titanium-containing main catalyst component.
wherein at least one of the magnesium-containing solution, the first reaction product and the second reaction product is brought into contact with an organic silicon compound having a formula SiR′_{c}(OR″)_{4-c} where R′ is independently an hydrocarbyl having 1 to 10 carbon atoms, R″ is independently an alkyl having 1 to 6 carbon atoms, and c is 0, 1, 2, or 3, prior to their use in the next step.

2. The process of claim 1 wherein the magnesium compound is prepared by reacting a powdered magnesium with an alkyl monohalide having 3 to 12 carbon atoms in an ether solvent, wherein the molar ratio of the powdered magnesium to the alkyl monohalide is in a range of from 1:1 to 1:3.

3. The process of claim 1, wherein the alcohol is a linear, branched, or cyclic aliphatic alcohol having 2 to 12 carbon atoms, and the alcohol is used in an amount of from 1 to 2 moles per mole of Mg in the magnesium compound.

4. The process of claim 3, wherein the alcohol is 2-ethylhexanol.

5. The process of claim 1, wherein said halogenating agent is selected from the group consisting of alkyl aluminum halides of a formula R³_{b}AlY_{3-b}, where R³ is independently an alkyl having 1 to 14 carbon atoms, 1≦b<3, and Y is halogen; halides of a formula MYᵢ, where M represents Si, C, B, Ti, or Pb, i is equal to the valence of M, and Y is halogen; and mono- or multihaloalkanes having 1 to 10 carbon atoms.

6. The process of claim 5, wherein said halogenating agent is selected from the group consisting of diethyl aluminum chloride, ethyl aluminum dichloride, diisopropyl aluminum chloride, ethyl aluminum sesquichloride, butyl aluminum sesquichloride, silicon tetrachloride, titanium tetrachloride, boron trichloride, carbon tetrachloride, lead tetrachloride, n-butyl chloride, n-propyl chloride, ethyl chloride, n-amyl chloride, 2-chlorobutane, 2-chloropropane, 2-chloroheptane, 3-chloroheptane, 2,2-dichloropropane, 2,2-dichlorobutane, 1,3-dichlorobutane, 1,2-dichloropropane, and t-butyl chloride.

7. The process of claim 5, wherein said halogenating agent is used in an amount of from 1 to 10 moles per mole of Mg in the magnesium compound.

8. The process of claim 1, wherein the organic silicon compound is selected from the group consisting of tetramethoxy silicane, tetraethoxy silicane, tetrapropoxy silicane, tetrabutoxy silicane and tetraisopropoxy silicane.

9. The process of claim 8, wherein the organic silicon compound is tetraethoxy silicane.

10. The process of claim 1, wherein the organic silicon compound is used in an amount of from 0.1 to 1.0 moles per mole of Mg in the magnesium compound.

11. The process of claim 1, wherein the inorganic oxide support is selected from the group consisting of silica, alumina, and mixtures thereof, and the inorganic oxide support is used in an amount of 0.2 to 1 gram per millimole of Mg in the magnesium compound.

12. The process of claim 1, wherein the titanium compound is used in an amount of from 0.15 to 1.0 moles per mole of Mg in the magnesium compound, and the alkyl aluminum compound is used in an amount of from 0.5 to 1.5 moles per mole of titanium compound.

13. The process of claim 1, wherein the magnesium-containing solution from step (i) is brought into contact with the organic silicon compound prior to its use in step (ii).

14. The process of claim 1, wherein the second reaction product from step (iii) is brought into contact with the organic silicon compound prior to its use in step (iv).

15. The process of claim 1, wherein the starting materials are used in the following amounts: 1 to 1.5 moles of the alcohol per mole of Mg in the magnesium compound; 0.1 to 0.5 moles of the organic silicon compound per mole of Mg in the magnesium compound; 0.2 to 0.5 moles of the titanium compound per mole of Mg in the magnesium compound; and 1.0 to 1.5 moles of the alkyl aluminum compound per mole of titanium compound.

16. A titanium-containing main catalyst component, which is obtained through a process according to claim 1.

17. A catalyst for ethylene polymerization, which comprises a reaction product of:
(1) the titanium-containing main catalyst component of claim 16; and
(2) an organoaluminum compound as a cocatalyst,
wherein the molar ratio of Ti in the titanium-containing main catalyst component to Al in the organoaluminum compound is in a range of from 1:30 to 1:300.

18. A process for producing ethylene polymers, comprising
(i) contacting ethylene and optional α-olefin comonomer(s) with the catalyst according to claim 17 under polymerization conditions; and
(ii) recovering the resulting ethylene polymers.
